(19) United States
(12) Patent Application Publication
(10) Pub. No.: US 2026/0361843 A1
(43) Pub. Date: Nov. 12, 2026

(54) DISPLAY PROCESSING APPARATUS, DISPLAY PROCESSING METHOD, AND STORAGE MEDIUM

(71) Applicant: SONY GROUP CORPORATION, TOKYO (JP)

(72) Inventors: SHIHHAO WEN, TOKYO (JP); MASATO AKAO, TOKYO (JP)

(21) Appl. No.: 19/123,998

(22) PCT Filed: Oct. 17, 2023
(86) PCT No.: PCT/JP2023/037470

§ 371 Date: Apr. 24, 2025

(30) Foreign Application Priority Data
Nov. 2, 2022 (JP) 2022-176005

(51) Int. Cl. H04N 13/398; H04N 13/383

(52) U.S. Cl. CPC H04N 13/398; H04N 13/383

(57) ABSTRACT

The present disclosure relates to a display processing apparatus, a display processing method, and a storage medium capable of displaying a hologram image with low latency and low power consumption.

A sampling interval of depth data of three-dimensional data in a central visual field of a user is resampled to be narrower than a sampling interval of depth data of three-dimensional data in a peripheral visual field of the user, wavefront propagation processing of color data of the three-dimensional data is performed on the basis of the depth data resampled, and a propagation signal representing a hologram is generated. The present disclosure may be applied to an augmented reality head mounted display (ARHMD).

### TECHNICAL FIELD

The present disclosure relates to a display processing apparatus, a display processing method, and a storage medium, and more particularly, to a display processing apparatus, a display processing method, and a storage medium capable of displaying a hologram image with low latency and low power consumption.

### BACKGROUND ART

Computer Generated Holography (CGH) technology has been proposed to be used for augmented reality head mounted displays (ARHMD).

The CGH technology electrically addresses a spatial light modulator (SLM) using a computer to control a direct light wave, and generates a hologram image by a light focusing effect generated by the direct light wave. Since the CGH technology is a technology realized by complex calculation, a processing load related to the calculation is large, and a processing time is required.

However, since the ARHMD or the like is an apparatus to be worn by the user, the size is limited, and thus the computer that can be mounted is also limited, and there is a possibility that a sufficient processing speed cannot be obtained in order to enable the hologram image realized by the CGH to be viewed without discomfort.

Therefore, it has been proposed to arrange a display panel that displays a hologram image including CGH as a 3D image in a central visual field region, and to arrange a display panel that displays a 2D image in a peripheral visual field region. As a result, it is possible to enhance a stereoscopic effect by a high-resolution 3D image while reducing the calculation processing amount as a whole (see Patent Document 1).

### CITATION LIST

### Patent Document

Patent Document 1: US Patent Application Publication No. 2022/179214 A

### SUMMARY OF THE INVENTION

### Problems to be Solved by the Invention

However, in the technique of Patent Document 1, a 3D image is not displayed in the entire display region, and the 2D image is viewed particularly in the peripheral visual field region, and thus the stereoscopic effect when the entire image is viewed is reduced, and there is a possibility that a discomfort occurs.

Furthermore, in order to reduce this discomfort, it is conceivable to widen the region where the 3D image is displayed. However, since the calculation amount related to the CGH technology increases due to an increase in the region where the 3D image is displayed, as a result, the calculation time increases, and there is a concern about occurrence of a delay related to display of the hologram image and an increase in power consumption.

The present disclosure has been made in view of such a situation, and particularly, the present disclosure is intended to display a hologram image without discomfort with low latency and low power consumption by effectively reducing the calculation amount according to the CGH technology.

### Solutions to Problems

A display processing apparatus and a storage medium according to one aspect of the present disclosure are a display processing apparatus including: a gaze information acquisition unit that acquires gaze information of a user from a sensor; a resampling processing unit that resamples a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and a wavefront propagation processing unit that performs wavefront propagation processing of color data of the three-dimensional data on the basis of the depth data resampled by the resampling processing unit and generates a propagation signal representing a hologram, and a storage medium storing a program for causing a computer to function as such a display processing apparatus.

A display processing method according to one aspect of the present disclosure is a display processing method including the steps of: acquiring gaze information of a user from a sensor; resampling a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and performing wavefront propagation processing of color data of the three-dimensional data on the basis of the depth data resampled and generating a propagation signal representing a hologram.

In one aspect of the present disclosure, gaze information of a user is acquired from a sensor, a sampling interval of depth data of three-dimensional data in a central visual field of the user corresponding to a line-of-sight direction of the user based on the gaze information is resampled to be narrower than a sampling interval of the depth data of the three-dimensional data in a peripheral visual field of the user, and wavefront propagation processing of color data of the three-dimensional data is performed on the basis of the depth data resampled to generate a propagation signal representing a hologram.

### BRIEF DESCRIPTION OF DRAWINGS

FIG. 1 is a diagram illustrating an example of three-dimensional data for explaining a principle of displaying a hologram image.

FIG. 2 is a diagram for explaining an RGB map and a depth map generated on the basis of the three-dimensional data of FIG. 1.

FIG. 3 is a diagram for explaining an example in which the depth map of FIG. 2 is expressed by the coordinate system in FIG. 1.

FIG. 4 is a diagram for explaining an example when the depth map of FIG. 3 is discretized and resampled.

FIG. 5 is a diagram for explaining a line-of-sight direction, a central visual field, an effective visual field, and a peripheral visual field of a human eye.

FIG. 6 is a diagram for explaining an example when the depth map of FIG. 3 is discretized and resampled by the method of the present disclosure.

FIG. 7 is a diagram for explaining another example when the depth map of FIG. 3 is discretized and resampled by the method of the present disclosure.

FIG. 8 is a diagram for explaining a configuration example of a display system of the present disclosure.

FIG. 9 is a diagram for explaining a configuration example of a modulation control unit in FIG. 8.

FIG. 10 is a diagram for explaining a positional relationship between a hologram image and a spatial light modulator when viewed from the user's eye.

FIG. 11 is a diagram for explaining occlusion processing when depth maps of all virtual objects are discretized with an equal number of layers and resampled.

FIG. 12 is a diagram for explaining occlusion processing when discretization and resampling are performed by the method of the present disclosure.

FIG. 13 is a flowchart for explaining modulation control processing by the modulation control unit in FIG. 9.

FIG. 14 is a diagram illustrating an arrangement example of Pa and Pb in Formulas (5) and (6).

FIG. 15 is a diagram for explaining a first modification when the depth map of FIG. 3 is discretized and resampled by the method of the present disclosure.

FIG. 16 is a diagram for explaining a second modification when the depth map of FIG. 3 is discretized and resampled by the method of the present disclosure.

FIG. 17 illustrates a configuration example of a general-purpose computer.

### MODE FOR CARRYING OUT THE INVENTION

Hereinafter, preferred embodiments of the present disclosure will be described in detail with reference to the accompanying drawings. Note that, in the present specification and the drawings, components having substantially the same functional configurations are denoted by the same reference signs, and redundant description is omitted.

Hereinafter, modes for carrying out the present technology will be described. The description will be given in the following order.
1. Overview of Present Disclosure
2. Preferred Embodiment
3. First Modification
4. Second Modification
5. Example Executed by Software

### 1. Overview of Present Disclosure

### <Principle of Displaying Hologram Image by Computer Generated Holography (CGH) Technology>

In particular, the present disclosure effectively reduces the calculation amount according to a computer generated holography (CGH) technology, thereby making it possible to display a hologram image without discomfort with low latency and low power consumption.

In describing the technology of the present disclosure, first, a principle of displaying a three-dimensional virtual object defined by three-dimensional data with a hologram image by a computer generated holography (CGH) technology will be described.

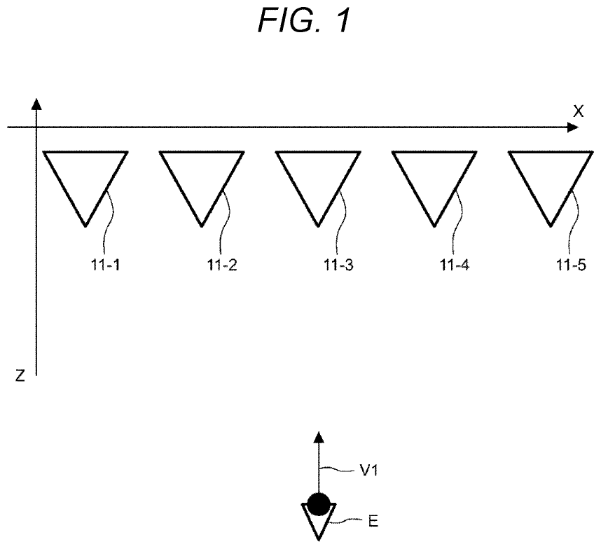

For example, a hologram image when viewed in the line-of-sight direction V1 by the viewer's eyes E in a case where five triangular prism-shaped virtual objects 11-1 to 11-5 are defined by three-dimensional data and arranged as illustrated in FIG. 1 will be considered.

Note that FIG. 1 is a top view of a state in which five virtual objects 11-1 to 11-5 are arranged upright in a horizontal direction (X direction), which is a lateral direction in the drawing, with a lower bottom surface constituted by a triangle being in contact with a floor surface, as viewed from an upper bottom surface side. In addition, although not illustrated, the front direction with respect to the paper surface of FIG. 1 is the Y direction, and the Z direction in the drawing is the depth direction as viewed from the viewer. Therefore, as illustrated in FIG. 1, the five virtual objects 11-1 to 11-5 are viewed by the viewer in a state where the vertex portions of the triangular prism extending in the vertical direction jump out toward the front side and are arranged in the horizontal direction.

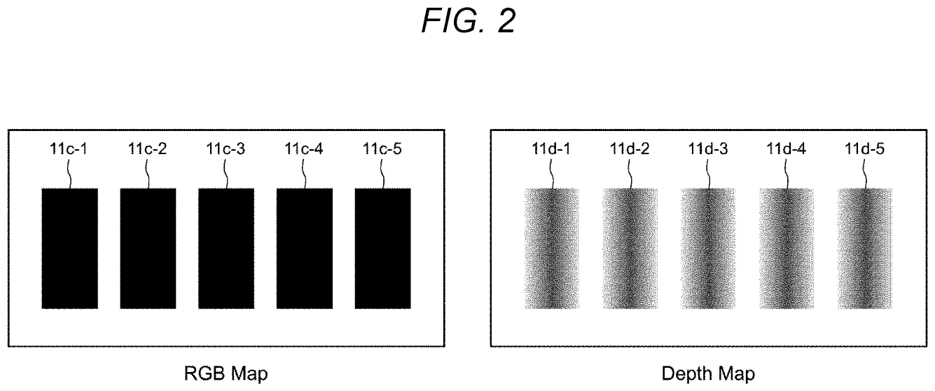

The three-dimensional data defined as the three-dimensional virtual objects 11-1 to 11-5 as illustrated in FIG. 1 is converted into a color map (RGB Map) including RGB data (color data) as texture information illustrated in the left part of FIG. 2 and a depth map illustrated in the right part of FIG. 2 by rendering corresponding to the line-of-sight direction V1.

In the color map including RGB data in the left part of FIG. 2, color arrangement distributions 11c-1 to 11c-5 respectively corresponding to virtual objects 11-1 to 11-5 are arranged from the left in the drawing. Note that, in the color map in the left part of FIG. 2, the color arrangement distributions 11c-1 to 11c-5 are expressed in the same color, but it is merely an example, and may be a distribution according to the color arrangement set on the surfaces of the virtual objects 11-1 to 11-5.

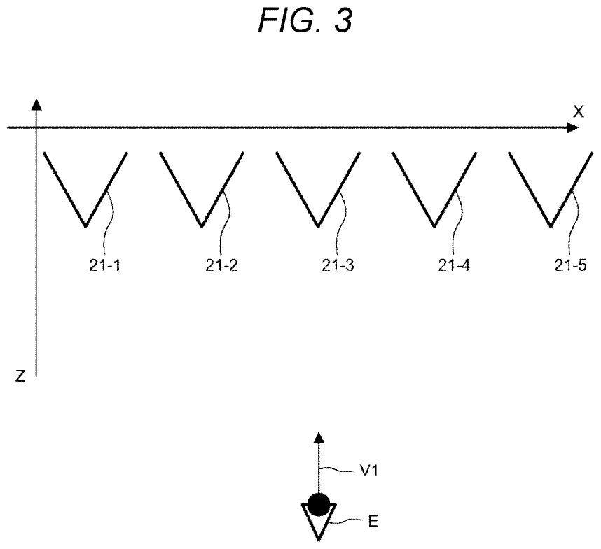

Furthermore, in the depth map in the right part of FIG. 2, depth distributions 11d-1 to 11d-5 respectively corresponding to virtual objects 11-1 to 11-5 are arranged from the left in the drawing. In the depth distributions 11d-1 to 11d-5, the depth value at a position closer to the viewer is expressed in black, and the depth value at a position farther from the viewer is expressed in white. The depth map in the right part of FIG. 2 is expressed, for example, as illustrated in FIG. 3 when converted into an expression from a direction corresponding to the top view of FIG. 1.

In the depth map of FIG. 3, the depth distributions 11d-1 to 11d-5 of FIG. 2 corresponding to the virtual objects 11-1 to 11-5 are expressed as depth distributions 21-1 to 21-5, respectively. Hereinafter, the color map and the depth map generated by the rendering based on the three-dimensional data are also collectively referred to as RGB+D data.

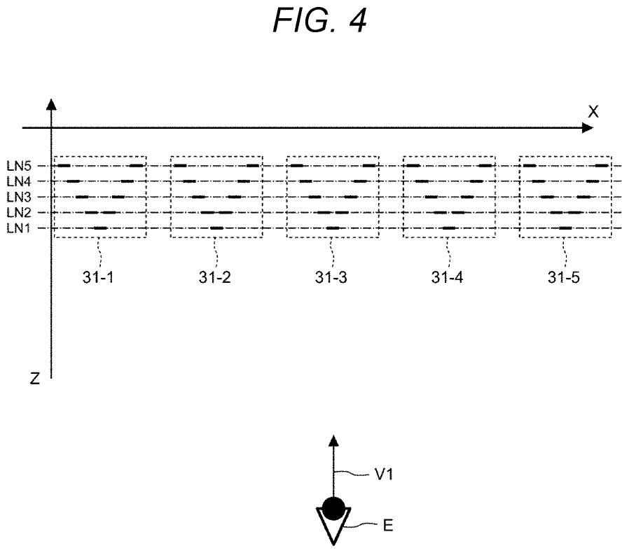

Next, in the RGB+D data generated by the rendering based on the three-dimensional data as described above, each depth value expressed by the depth distribution of the depth map is discretized and resampled so as to have a coarse granularity. More specifically, in order to make the granularity of the depth value coarser, the granularity of the depth value is resampled so as to be expressed by a plurality of layers of coarse granularity. That is, the depth value is discretized as illustrated in FIG. 4, and is resampled so as to be expressed by five layers, for example.

In FIG. 4, the depth distributions 21-1 to 21-5 of FIG. 3 corresponding to the virtual objects 11-1 to 11-5, respectively, are discretized into five layers LN1 to LN5 and resampled, from the left in the drawing, to be expressed as depth distributions 31-1 to 31-5. As described above, the complex wavefront information is generated by the wavefront propagation processing based on the RGB+D data including the depth map expressed by the depth distributions 31-1 to 31-5 including the five layers LN1 to LN5 and the color map illustrated in the left part of FIG. 2. Then, the spatial light modulator is controlled on the basis of the generated complex wavefront information, so that the hologram image is projected and viewed by the viewer.

The above is the principle of displaying the hologram image by the CGH technology. Here, by reducing the number of layers when the depth value is discretized, in other words, by reducing the number of samplings and widening the interval between the layers, the calculation amount according to the CGH technology can be reduced.

However, if the number of layers in the depth direction is reduced and the interval between the layers is widened, the depth cannot be expressed in detail, so that the stereoscopic effect may be reduced. That is, as the number of layers in the depth direction is increased and the interval between the layers is narrowed, the stereoscopic effect can be expected to be improved, but the calculation amount increases, and there is a concern about a delay in processing and an increase in power consumption due to an increase in the calculation amount.

On the other hand, since the calculation amount can be reduced as the number of layers in the depth direction is reduced and the interval between the layers is increased, it is possible to suppress the processing delay and realize power saving, but the stereoscopic effect is reduced, and there is a possibility that the viewer viewing the hologram image will feel discomfort. In this way, if it is attempted to achieve low latency and power saving by simply reducing the number of layers in the depth direction and widening the interval between the layers, the stereoscopic effect is reduced, and there is a possibility that a sense of discomfort is given.

By the way, it is known that human eyes have high sensitivity and can accurately recognize a shape and a color in a central visual field having a predetermined range centered on a line-of-sight direction, but have low sensitivity and can only recognize a shape and a color vaguely in a peripheral visual field other than the central visual field.

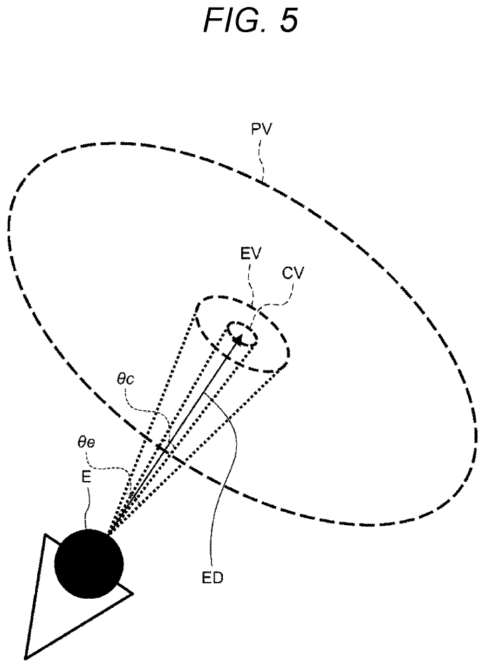

More specifically, as illustrated in FIG. 5, when the eye E of the viewer gazes and views at the line-of-sight direction ED indicated by the arrow, three types of visual fields including a central visual field CV, an effective visual field EV, and a peripheral visual field PV are known centered on the line-of-sight direction ED.

The central visual field CV is a visual field in a range forming a predetermined viewing angle θc (θc is, for example, about 2 degrees) centered on the line-of-sight direction, and is a visual field in which the shape and color of the object can be clearly recognized with high sensitivity.

The effective visual field EV is a visual field outside the central visual field CV and in a range forming a predetermined viewing angle θe (θe is, for example, about 20 degrees) centered on the line-of-sight direction ED, and is a visual field in which the shape and color of the object can be recognized to some extent although the degree of recognition is lower than that of the central visual field CV.

The peripheral visual field PV is a range outside the effective visual field EV, and is a visual field in which the sensitivity is low and the shape and color can only be recognized vaguely.

Note that, in FIG. 5, the peripheral visual field PV is expressed as a range indicated by a dotted line, but the entire visual field of the range outside the effective visual field EV is the peripheral visual field. Therefore, in FIG. 5, the visual field of the range including the entire range outside the range surrounded by the dotted line of the effective visual field EV is the peripheral visual field.

Furthermore, hereinafter, a visual field obtained by combining the central visual field CV and the effective visual field EV, which is a visual field in which the shape and color can be recognized to some extent or more by the human eye, is collectively referred to as a central visual field CV. That is, in the following description, unless otherwise specified, the central visual field is a visual field in a range in which the central visual field CV and the effective visual field EV in FIG. 5 are combined.

Therefore, in the present disclosure, the number of layers (the number of samplings) is increased in the depth direction for the virtual object 11 existing in a range closer to the line-of-sight direction, and the layer interval is set to be narrower. In addition, on the other hand, the number of layers in the depth direction is reduced and the interval between the layers is set to be wider for the virtual object 11 existing in a range farther from the line-of-sight direction, that is, in the peripheral visual field.

Hitherto, as illustrated in FIG. 4, all of the depth distributions 21-1 to 21-5 in FIG. 3 corresponding to the virtual objects 11-1 to 11-5 are resampled by the five layers LN1 to LN5 so as to be discretized with the equal number of layers and at equal intervals between the layers, whereby the depth distributions 31-1 to 31-5 have been obtained.

On the other hand, in the present disclosure, as an angle (hereinafter, also referred to as a line-of-sight parallax angle) formed by a direction (hereinafter, also referred to as an object direction) viewed from the eye E for each virtual object 11 and a line-of-sight direction increases, resampling is performed such that the number of layers to be discretized is reduced and an interval between the layers increases. As a result, the number of layers as the entire image is appropriately reduced according to the sensitivity of the eye E, so that the calculation amount can be effectively reduced. As a result, it is possible to suppress the occurrence of delay while displaying a hologram image without discomfort and to realize power saving.

Note that the virtual object direction, which is a direction viewed from the eye E (viewpoint position of the user) for each virtual object 11, may be a direction on a straight line connecting a specific position of each virtual object 11 from the eye E (viewpoint position of the user), for example, a barycentric position, a closest position, a farthest position, or the like.

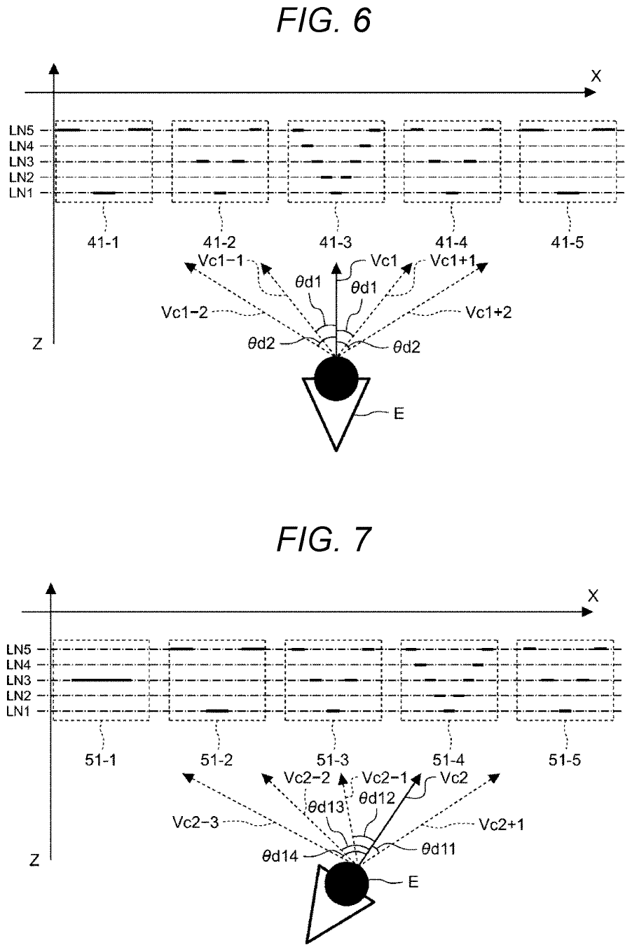

For example, as illustrated in FIG. 6, when the line-of-sight direction is Vc1, the line-of-sight direction Vc1 is the virtual object direction itself. Therefore, the line-of-sight parallax angle of the virtual object 11-3 (FIG. 1) located in the line-of-sight direction Vc1 and in the virtual object direction is 0, which is the minimum value. Therefore, the depth distribution 21-3 corresponding to the virtual object 11-3 is discretized into the maximum number of five layers LN1 to LN5 and resampled as in the depth distribution 41-3.

Furthermore, when the virtual object directions are the directions Vc1−1 and Vc1+1 with respect to the line-of-sight direction Vc1, the line-of-sight parallax angles of the virtual objects 11-2 and 11-4 located in the virtual object directions Vc1−1 and Vc1+1 are θd1 (>0). For this reason, the depth distributions 21-2 and 21-4 corresponding to the virtual objects 11-2 and 11-4 are discretized into three layers LN1, LN3, and LN5 having a smaller number of layers and a wider interval than the virtual object 11-3 as in the depth distributions 41-2 and 41-4, and resampled.

Then, when the virtual object directions are the directions Vc1−2 and Vc1+2 with respect to the line-of-sight direction Vc1, the line-of-sight parallax angles of the virtual objects 11-1 and 11-5 located in the virtual object directions Vc1−2 and Vc1+2 are θd2 (>θd1). For this reason, the depth distributions 21-1 and 21-5 corresponding to the virtual objects 11-1 and 11-5 are discretized into two layers LN1 and LN5 having a further smaller number of layers and a wider interval than the virtual objects 11-2 and 11-4 as in the depth distributions 41-1 and 41-5, and resampled.

Furthermore, as illustrated in FIG. 7, when the line-of-sight direction is Vc2, the line-of-sight direction Vc2 is the virtual object direction itself. Therefore, the line-of-sight parallax angle of the virtual object 11-4 located in the line-of-sight direction Vc2 and in the virtual object direction is 0, which is the minimum value. Therefore, the depth distribution 21-4 corresponding to the virtual object 11-4 is discretized into the maximum number of five layers LN1 to LN5 as in the depth distribution 51-4, and resampled.

In addition, when the virtual object directions are the directions Vc2+1 and Vc2−1 with respect to the line-of-sight direction Vc2, the line-of-sight parallax angles of the virtual objects 11-3 and 11-5 located in the virtual object directions Vc2+1 and Vc2−1 are θd11 and θd12 (θd11≈θd12) (>0). Therefore, the depth distributions 21-3 and 21-5 corresponding to the virtual objects 11-3 and 11-5 are discretized into three layers LN1, LN3, and LN5 having a wider interval than the five layers of the virtual object 11-4 as in the depth distributions 51-3 and 51-5, and resampled.

Furthermore, when the virtual object direction is the direction Vc-2 with respect to the line-of-sight direction Vc2, the line-of-sight parallax angle of the virtual object 11-2 located in the virtual object direction Vc-2 is θd13 (>θd11, θd12). For this reason, the depth distribution 21-2 corresponding to the virtual object 11-2 is discretized into two layers LN1 and LN5 having a wider interval than the three layers of the virtual objects 11-3 and 11-5 as in the depth distribution 51-2, and resampled.

Then, when the virtual object direction is the direction Vc2−3 with respect to the line-of-sight direction Vc2, the line-of-sight parallax angle of the virtual object 11-1 located in the virtual object direction Vc2−3 is θd14 (>θd13). Therefore, the depth distribution 21-1 corresponding to the virtual object 11-1 is discretized into only one layer LN3, which is smaller than the two layers of the virtual object 11-2 as in the depth distribution 51-1, and resampled.

In any of the examples of FIGS. 6 and 7, the virtual object 11 having the line-of-sight parallax angle closer to the line-of-sight direction is set to have a larger number of layers (number of samplings) in the depth direction and to have a narrower interval between the layers. Then, as the virtual object 11 has a line-of-sight parallax angle farther from the line-of-sight direction, the number of layers in the depth direction is reduced, and the interval between the layers is set wider.

In summary, the number of layers in the depth direction is larger and the interval between the layers is set to be narrower for the virtual object 11 in the range closer to the central visual field with a smaller line-of-sight parallax angle closer to the line-of-sight direction. Therefore, in a range in which the shape and color of the object can be recognized with high sensitivity by the user's eye E, the virtual object in which the depth direction is expressed in detail is displayed. On the other hand, the number of layers in the depth direction is reduced and the interval between the layers is set to be wider for the virtual object 11 having a larger line-of-sight parallax angle away from the line-of-sight direction and being in the peripheral visual field. Therefore, the virtual object is expressed in a state in which the expression in the depth direction is simplified, but the influence is small because the user's eye E can only recognize the shape and color of the object vaguely in the peripheral visual field. In addition, the virtual object in the central visual field is limited relative to the region of the entire hologram image. However, the virtual objects in the peripheral visual field are all virtual objects other than the central visual field. Therefore, by reducing the number of layers of the virtual object in the peripheral visual field, the calculation amount of the entire hologram image can be effectively reduced. As a result, it is possible to display a hologram image with a high stereoscopic effect and without discomfort while reducing the overall calculation amount related to the CGH technology and realizing low latency and power saving.

### 2. Preferred Embodiment

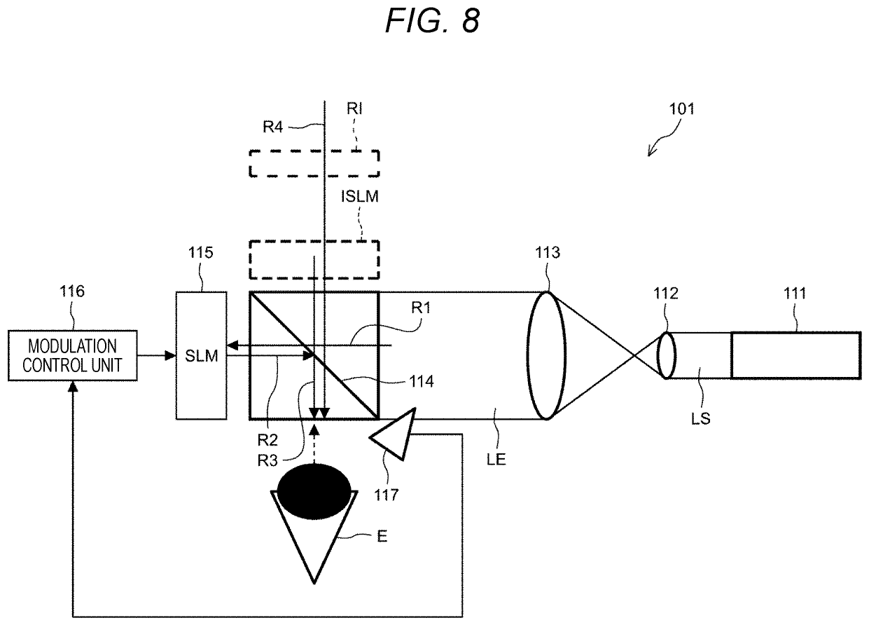

Next, a configuration example of a preferred embodiment of a display system that displays a hologram image will be described with reference to FIG. 8.

The hologram image display system of the present disclosure has a configuration assuming an augmented reality head mounted display (ARHMD) used by being worn by a user, but may have another configuration as long as the hologram image can be displayed.

More specifically, a display system 101 in FIG. 8 includes a light source 111, lenses 112 and 113, a beam splitter 114, a spatial light modulator (SLM) 115, a modulation control unit 116, and a line-of-sight detection unit 117.

The light source 111 generates laser light constituted by coherent light and causes the laser light to be incident on the spatial light modulator 115 via the lenses 112 and 113 and the beam splitter 114.

As illustrated in FIG. 8, the lenses 112 and 113 enlarge (adjusts) the beam diameter of the laser light LS, which is coherent light from the light source 111, in accordance with the size of the display surface of the spatial light modulator 115 like the laser light LE including coherent light. The laser light LE whose beam diameter is enlarged by the lenses 112 and 113 enters the spatial light modulator 115 via the beam splitter 114. Note that FIG. 8 illustrates an example in which the lenses 112 and 113 include two lenses. However, as long as the beam diameter of the laser light LS which is coherent light from the light source 111 can be enlarged like the laser light LE including coherent light, two or more lenses or other optical systems may be included.

As illustrated in FIG. 8, the beam splitter 114 transmits the incident light LE whose beam diameter is enlarged by the lenses 112 and 113 in the direction of the arrow R1 to be incident on the spatial light modulator 115 including the SLM. Furthermore, the beam splitter 114 reflects the modulated light from the direction of the arrow R2, which has been modulated and reflected by the spatial light modulator 115 on the incident light LE, in the direction of the arrow R3 toward the eye E of the user who is the viewer, and causes the modulated light to be incident on the eye E of the user. Further, the beam splitter 114 transmits incident light from the real space in the direction of the arrow R4 to be incident on the user's eye E.

The spatial light modulator (SLM) 115 is controlled by the modulation control unit 116. In addition, the spatial light modulator 115 electrically controls the spatial distribution (amplitude, phase, polarization, or the like) of the incident light including the laser light LE emitted from the light source 111 and having the beam diameter expanded by the lenses 112 and 113 to modulate (change the light) and reflect the incident light. The spatial light modulator 115 includes, for example, an element such as a liquid crystal. The spatial light modulator 115 generates a hologram image by changing a wavefront shape by modulating the laser light LE as incident light by controlling an element such as liquid crystal by the modulation control unit 116. Hereinafter, the incident light including the laser light LE is also simply referred to as the incident light LE. In addition, an example in which the spatial light modulator 115 in the present embodiment is configured by a reflective SLM will be described, but may be configured by a transmissive SLM. Furthermore, in the present embodiment, the spatial light modulator 115 will be described by taking a phase-only SLM as an example, but is not limited thereto, and may be, for example, an amplitude-only SLM.

That is, since the spatial light modulator 115 of FIG. 8 is of the reflection type and the phase-only type, the incident light LE including the coherent light incident in the direction of the arrow R1 is modulated, and the reflected light as the hologram image including the modulated light is reflected in the directions of the arrows R2 and R3 to be incident on the user's eye E. As a result, the reflected light as the hologram image is projected on the mirror image ISLM of the spatial light modulator 115, and thus, is viewed as the hologram image RI by the user's eye E. At this time, since the incident light from the real space is also incident on the user's eye E from the direction of the arrow R4, the hologram image RI superimposed on the real space is viewed in the user's eye E. As a result, the user views the hologram image RI displayed by AR on the real space through the beam splitter 114.

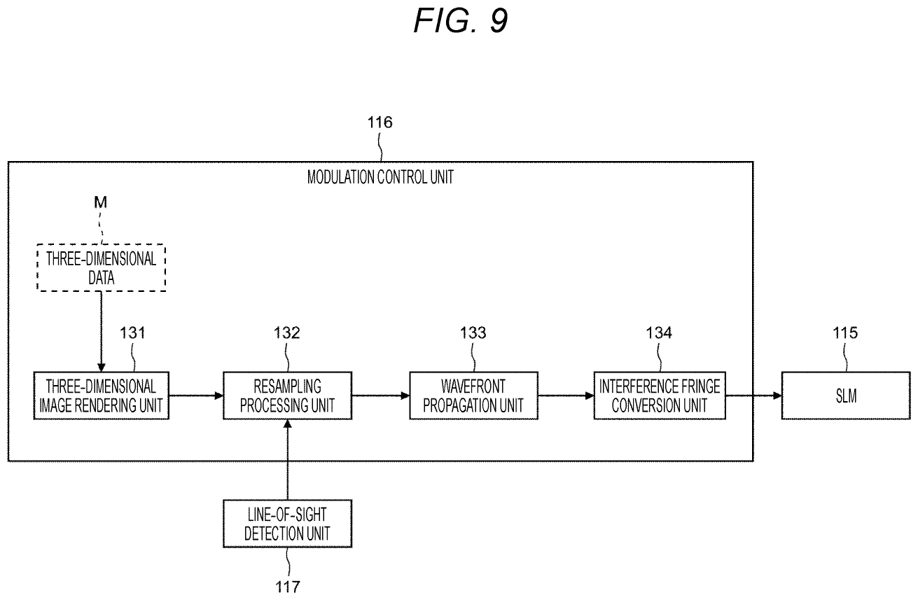

The modulation control unit 116 generates complex wavefront information on the basis of RGB+D data including a color map and a depth map obtained by rendering from three-dimensional data defining a virtual object and the information on the line-of-sight direction of the user detected by the line-of-sight detection unit 117. More specifically, the modulation control unit 116 generates complex wavefront information by wavefront propagation processing using the principle as described with reference to FIGS. 1 to 7, and controls the spatial light modulator 115 on the basis of the generated complex wavefront information. Note that a detailed configuration example of the modulation control unit 116 will be described later in detail with reference to FIG. 9.

The line-of-sight detection unit 117 includes, for example, an inertial measurement unit (IMU) provided in the display system 101 including an ARHMD mounted on the head of the user, and a sensor such as a camera that acquires images of the eyes and the face of the user. The line-of-sight detection unit 117 outputs information acquired by such a sensor to the modulation control unit 116 as gaze information for specifying the line-of-sight direction of the user. Note that, in the present embodiment, the line-of-sight direction may be not only the line-of-sight direction based on the position of the user's eye but also a normal direction near the center of the user's face in the real space. Furthermore, the line-of-sight direction may be a normal direction at the center position of both eyes of the user or a normal direction of both eyes, one eye, or the forehead of the head of the user. Therefore, hereinafter, sensor information acquired by various sensors provided in the line-of-sight detection unit 117 for specifying these line-of-sight directions will be collectively referred to as gaze information. Then, the line-of-sight direction is specified on the basis of the gaze information.

### <Configuration Example of Modulation Control Unit>

Next, a configuration example of the modulation control unit 116 will be described with reference to FIG. 9. The modulation control unit 116 in FIG. 9 includes a three-dimensional image rendering unit 131, a resampling processing unit 132, a wavefront propagation unit 133, and an interference fringe conversion unit 134.

The three-dimensional image rendering unit 131 generates an RGB map including RGB data (texture information) of a virtual object and a depth map including depth information of the virtual object by rendering based on the three-dimensional data M of the virtual object to be displayed. Then, the three-dimensional image rendering unit 131 combines the generated RGB map and the depth map, and outputs the RGB map and the depth map to the resampling processing unit 132 as RGB+D data.

As described with reference to FIGS. 1 to 7, the resampling processing unit 132 specifies the line-of-sight direction of the user on the basis of the gaze information supplied from the line-of-sight detection unit 117, and performs resampling by discretizing while adjusting the number of layers of the depth map for each virtual object. Then, the resampling processing unit 132 outputs RGB+D data including the depth map of the number of resampled layers and the RGB map to the wavefront propagation unit 133.

The wavefront propagation unit 133 performs wavefront propagation processing on the RGB+D data resampled by the resampling processing unit 132, thereby generating a propagation signal including complex wavefront information of a hologram pattern corresponding to an image of a hologram image to be displayed on the spatial light modulator 115. Then, the wavefront propagation unit 133 outputs the generated propagation signal to the interference fringe conversion unit 134.

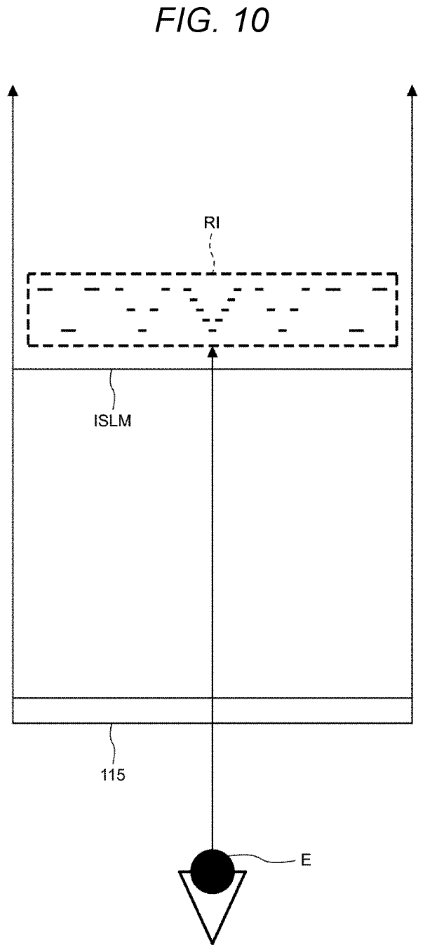

More specifically, the wavefront propagation unit 133 performs occlusion processing on the basis of depth map information among the RGB+D data, and repeats processing of sequentially superimposing RGB data of a layer on the back side in the depth direction with RGB data existing in a layer immediately in front. Then, the wavefront propagation unit 133 implements wavefront propagation processing by finally propagating RGB data of all layers to the frontmost layer, and generates a propagation signal including complex wavefront information corresponding to one hologram pattern. Note that the occlusion processing will be described later in detail with reference to FIGS. 10 to 12.

The interference fringe conversion unit 134 encodes the propagation signal including the complex wavefront information generated by the wavefront propagation unit 133 into amplitude information or phase information, and outputs the amplitude information or the phase information to the spatial light modulator 115.

With the above configuration, the spatial light modulator 115 modulates the incident light LE on the basis of the amplitude information or the phase information supplied from the interference fringe conversion unit 134 of the modulation control unit 116, thereby displaying the hologram image including the virtual object defined by the three-dimensional data M.

### <Occlusion Processing>

Here, occlusion processing will be described. Note that, for the description, it is assumed that the hologram image viewed from the user's eye E is viewed as the hologram image RI on the mirror image ISLM of the spatial light modulator 115 by the function realized by the beam splitter 114 as illustrated in FIG. 10. Furthermore, the hologram image RI of FIG. 10 includes virtual objects 11-1 to 11-5 by modulation to the incident light LE by the spatial light modulator 115 based on RGB+D data including the depth maps of the depth distributions 41-1 to 41-5 of FIG. 6.

In this case, when the hologram image RI is viewed from the user's eye E, the triangular prism-shaped virtual objects 11-1 to 11-5 are viewed as a shape in which the vertex of the triangle protrudes from the center in the front direction and the end portion in the horizontal direction is recessed in the depth direction when viewed from the top. However, the image is displayed as one 2D image on the display surface (surface on which incident light LE is modulated and a hologram image as a modulation result is reflected: SLM position) of the spatial light modulator 115. This 2D image can be considered as an image configured on a surface closest to the mirror image ISLM of the spatial light modulator 115 in FIG. 10, that is, closest to the user's eye E. This single 2D image is generally called a wavefront recording plane (WRP).

The wavefront recording plane (WRP) is generated by sequentially overlapping the texture information (RGB data) of each layer from the farthest layer in the depth direction from the user's eye E, on the basis of the depth map and RGB map in the RGB+D data, layer by layer toward the front. Therefore, the texture information of all the layers is propagated to the frontmost layer on the wavefront recording plane. Therefore, the wavefront recording plane corresponds to one hologram pattern of the frontmost layer in which the texture information of all the layers is overlapped on the texture information of the front layer. The occlusion processing is processing of generating this wavefront recording plane on the basis of RGB+D data. That is, the occlusion processing is processing in which, on the basis of the depth data, the texture information of the overlapping front layers is sequentially overlaid on the texture information of the farthest layer, starting from the farthest layer and propagating the texture information of all layers to the frontmost layer.

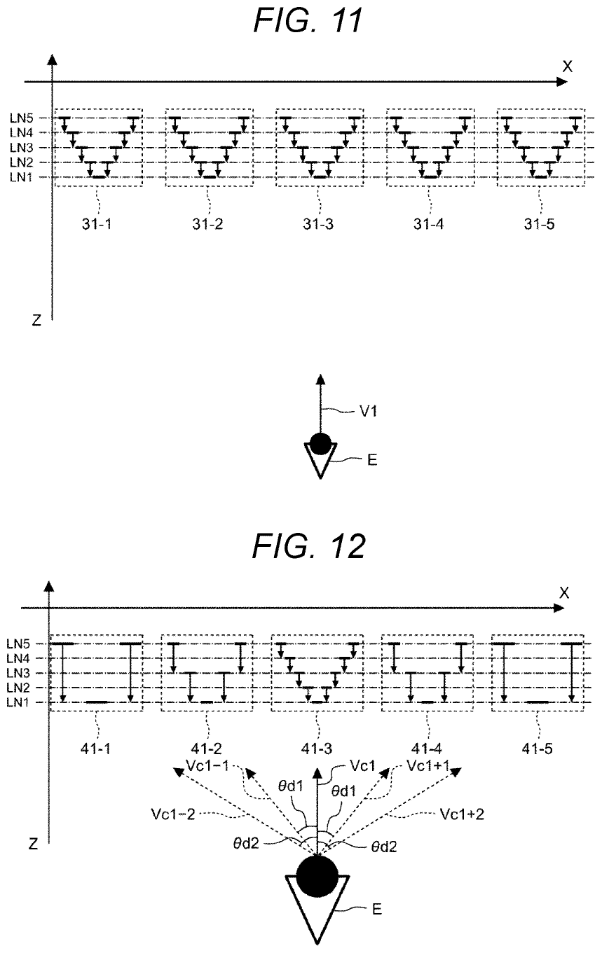

This occlusion processing is as follows, for example, when the depth data related to all the virtual objects are all equally the same number of layers and are configured at intervals between the same layers, in other words, for example, in a case illustrated in FIG. 11. Note that, in FIG. 11, depth distributions 31-1 to 31-5 including five layers are set for all the virtual objects 11-1 to 11-5.

First, occlusion processing between the layer LN5 and the layer LN4 will be described. In this occlusion processing, the texture information of the layer LN5 is propagated to the texture information of the layer LN4 as indicated by an arrow. When the texture information of the layer LN5 propagated to the layer LN4 overlaps the texture information in the layer LN4, the texture information of the layer LN5 is replaced with the texture information of the layer LN4. By this occlusion processing, the texture information of the layer LN4 is superimposed on the texture information corresponding to the depth data of the layer LN5.

Next, by occlusion processing between the layer LN4 and the layer LN3, the texture information of the layer LN4 is propagated to the texture information of the layer LN3 as indicated by an arrow. When the texture information of the layer LN4 propagated to the layer LN3 overlaps the texture information in the layer LN3, the texture information of the layer LN4 is replaced with the texture information of the layer LN3. By this occlusion processing, the texture information of the layer LN3 is superimposed on the texture information corresponding to the depth data of the layer LN4.

Furthermore, similarly, the texture information of the layer LN3 is propagated to the texture information of the layer LN2 as indicated by an arrow by the occlusion processing between the layer LN3 and the layer LN2. When the texture information of the layer LN3 propagated to the layer LN2 overlaps the texture information in the layer LN2, the texture information of the layer LN3 is replaced with the texture information of the layer LN2. By this occlusion processing, the texture information of the layer LN2 is superimposed on the texture information corresponding to the depth data of the layer LN3.

Furthermore, similarly, the texture information of the layer LN2 is propagated to the texture information of the layer LN1 as indicated by an arrow by the occlusion processing between the layer LN2 and the layer LN1. When the texture information of the layer LN2 propagated to the layer LN1 overlaps the texture information in the layer LN1, the texture information of the layer LN2 is replaced with the texture information of the layer LN1. By this occlusion processing, the texture information of the layer LN1 is superimposed on the texture information corresponding to the depth data of the layer LN2. Then, by the series of processing, all the texture information is propagated to the texture information of the layer LN1.

In this way, the occlusion processing is processing implemented by repeatedly overlaying the texture information of the layer immediately in front of the farthest layer sequentially for each virtual object, starting from the texture information of the farthest layer. For this reason, in the occlusion processing, parallel processing cannot be performed, and the calculation amount becomes extremely enormous.

On the other hand, in the present disclosure, as described above, the number of layers (the number of samplings) is large and the interval between the layers is set to be narrow for the virtual object existing in the region close to the central visual field according to the line-of-sight parallax angle that is the angle formed by the line-of-sight direction and the virtual object direction. Furthermore, for the virtual object existing in the peripheral visual field away from the central visual field, the number of layers (the number of samplings) is small, and the interval between the layers is set wide.

Therefore, for example, among the same virtual objects 11-1 to 11-5, the line-of-sight parallax angle is 0 for the virtual object 11-3 in which the line-of-sight direction Vc1 is the virtual object direction. Therefore, as illustrated in FIG. 12, for example, the depth distribution 41-3 corresponding to the virtual object 11-3 includes the maximum number of five layers. In addition, the depth distributions 41-2 and 41-4 corresponding to the virtual objects 11-2 and 11-4 have a line-of-sight parallax angle of θd1 (>0), and thus, are configured by three layers smaller than the depth distribution 41-3. Furthermore, the depth distributions 41-1 and 41-5 corresponding to the virtual objects 11-1 and 11-5 have a line-of-sight parallax angle of θd2 (>θd1), and thus, are configured by two layers smaller than the depth distributions 41-2 and 41-4. With such a configuration, the occlusion processing in the present disclosure is as follows.

First, in FIG. 12, in the depth distribution 41-3, the texture information of the layer LN5 is propagated to the texture information of the layer LN4 as indicated by an arrow. Furthermore, the texture information of the layer LN4 is propagated to the texture information of the layer LN3 as indicated by an arrow. Furthermore, the texture information of the layer LN3 is propagated to the texture information of the layer LN2 as indicated by an arrow. Then, the texture information of the layer LN2 is propagated to the texture information of the layer LN1 as indicated by an arrow. By this series of processing, the texture information of all the layers corresponding to the virtual object 11-3 is propagated to the texture information of the layer LN1. That is, the number of times of propagation of the depth distribution 41-3 is 4 similarly to the case of FIG. 11.

On the other hand, in the depth distributions 41-2 and 41-4 corresponding to the virtual objects 11-2 and 11-4, first, as indicated by the arrow, the texture information of the layer LN5 is propagated to the texture information of the layer LN3. Next, as indicated by the arrow, the texture information of the layer LN3 is propagated to the texture information of the layer LN1, so that the texture information of all the layers corresponding to the virtual objects 11-2 and 11-4 is propagated to the texture information of the layer LN1. That is, the number of times of propagation of the depth distributions 41-2 and 41-4 is 2, which is smaller than the number of times of propagation of the depth distribution 41-3, which is 4.

Then, in the depth distributions 41-1 and 41-5 corresponding to the virtual objects 11-1 and 11-5, the texture information of the layer LN5 is propagated to the texture information of the layer LN1 as indicated by the arrow. As a result, the texture information of all the layers corresponding to the virtual objects 11-1 and 11-5 is propagated to the texture information of the layer LN1. That is, the number of times of propagation of the depth distributions 41-1 and 41-5 is 1, which is smaller than the number of times of propagation of any of 4 times and 2 times of the depth distributions 41-2 to 41-4.

As a result, the total number of times of propagation indicated by the arrow in the occlusion processing in FIG. 12 is smaller than the total number of times of propagation in the occlusion processing in FIG. 11, and the number of times of propagation is reduced as a whole. As a result, since the calculation amount is reduced, it is possible to display a hologram image without discomfort and to reduce a delay caused by an increase in processing time related to calculation processing and power consumption related to calculation.

### <Modulation Control Processing>

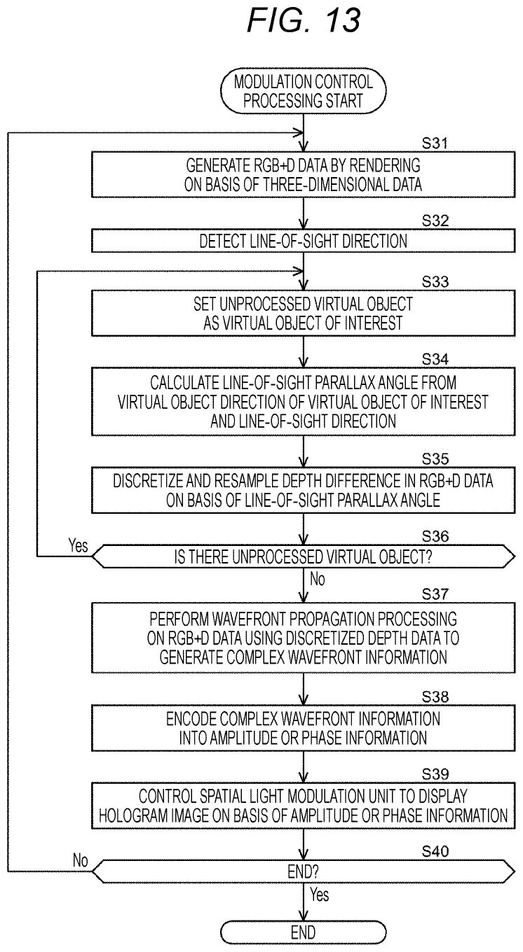

Next, modulation control processing by the modulation control unit 116 in FIG. 9 will be described with reference to a flowchart in FIG. 13.

In step S31, the three-dimensional image rendering unit 131 generates an RGB map including texture information of an object and a depth map indicating a depth of the object by performing rendering on the basis of three-dimensional data input from the outside. Then, the three-dimensional image rendering unit 131 outputs the RGB map and the depth map together to the resampling processing unit 132 as RGB+D data.

More specifically, for example, the three-dimensional image rendering unit 131 assigns a colored pixel value, which is corresponding texture information, to pixels in a region of a virtual object, and sets black to a region in which an image on which other virtual objects are projected does not exist. Furthermore, for example, the three-dimensional image rendering unit 131 gives a depth value corresponding to the distance from the spatial light modulator 15 to the projection position where the virtual object is projected to the pixels in the region of the virtual object. Further, the three-dimensional image rendering unit 131 gives a white depth value indicating that the distance from the spatial light modulator 15 is infinite to pixels in a region other than the region of the virtual object. As described above, the three-dimensional image rendering unit 131 generates a depth map by assigning depth values to the entire region.

In step S32, the line-of-sight detection unit 117 detects the line-of-sight direction of the user's eye E and outputs the detected direction to the resampling processing unit 132 as gaze information.

In step S33, the resampling processing unit 132 sets any of the unprocessed virtual objects as the virtual object of interest on the basis of the RGB+D data.

In step S34, the resampling processing unit 132 specifies the line-of-sight direction on the basis of the gaze information, and calculates a line-of-sight parallax angle which is an angle formed by the virtual object direction of the virtual object of interest and the line-of-sight direction.

In step S35, the resampling processing unit 132 discretizes and resamples the depth value in the depth map of the RGB+D data on the basis of the line-of-sight parallax angle, and outputs the depth value to the wavefront propagation unit 133. More specifically, as described with reference to FIGS. 1 to 7, as the line-of-sight parallax angle increases, the resampling processing unit 132 discretizes the depth value by increasing the interval between the layers with a smaller number of layers (number of samplings), and resamples the depth map. At this time, the wavefront propagation unit 133 stores RGB+D data to be a resampling result in association with the virtual object of interest.

In step S36, the resampling processing unit 132 determines whether or not there is an unprocessed virtual object, and when there is an unprocessed virtual object, the process returns to step S33. As a result, the processing of steps S33 to S36 is repeated until the depth map in the RGB+D data is resampled on the basis of the line-of-sight direction for all the virtual objects. Then, for all the virtual objects, resampling of the depth map in the RGB+D data based on the line-of-sight direction is performed, and when it is determined in step S36 that there is no unprocessed virtual object, the process proceeds to step S37.

In step S37, the wavefront propagation unit 133 generates a propagation signal by wavefront propagation processing based on the RGB+D data of all the resampled virtual objects. The propagation signal is a complex signal expressing a hologram pattern of a virtual object projected at a position where the spatial light modulator 115 is arranged. The wavefront propagation unit 133 outputs the generated propagation signal to the interference fringe conversion unit 134.

The arithmetic processing for generating the propagation signal of the hologram pattern depends on the type of the spatial light modulator 115, the propagation distance, and the encoding method. In the present embodiment, a case where phase-only liquid crystal on silicon (LCoS) is used as the spatial light modulator 115 will be exemplified.

When the propagation distance is in the range of several hundred mm, the wavefront propagation can be expressed by the Fresnel diffraction formula. In addition, a dual-phase encoding algorithm can be used for the phase-only encoding. Hereinafter, a propagation formula and an encoding algorithm according to the present embodiment will be described.

The wavefront propagation unit 133 propagates each point represented in pixel units by using a Fresnel wavefront diffraction formula illustrated in the following Formula (1).

$$\begin{matrix}[ Math . 1 ] & \\ E ( x , y , z ) = \frac{1}{i λ} \int {\int }_{- ∞}^{∞} E ( {x}^{′} , {y}^{′} , 0 ) \frac{{e}^{ikr}}{r} cos ( θ ) {dx}^{′} , {dy}^{′} & ( 1 )\end{matrix}$$

Here, in Formula (1), x and y in (x, y, z) are pixel positions on the hologram image (hologram pattern) projected by the spatial light modulator 115. Further, z is a distance from a display position in the real space where each point is displayed to the SLM position where the spatial light modulator 115 is arranged. (x′, y′, 0) is a pixel position on the display surface of the spatial light modulator 115. k is a wave number (2π/λ) of the wavelength λ. i is an imaginary unit. Further, r is defined by the following Formula (2):

[Math. 2]

r=\sqrt{(x−x′)²+(y−y′)²+z²} (2)

In the present example, the values of all points are summed to generate a hologram pattern, as illustrated in Formula (1). Furthermore, as described with reference to FIGS. 10 to 12, a propagation algorithm considering occlusion processing of individual points is used. In addition, another wave propagation function may be used to generate the hologram pattern at the SLM position. For example, Rayleigh-Sommerfeld diffraction formula or Fraunhofer diffraction formula, which can be used on different assumptions, may be used.

In step S38, the interference fringe conversion unit 134 executes hologram pattern conversion processing, and converts the complex number field represented by the complex signal generated in the wavefront propagation unit 133 into a phase signal of a hologram pattern that can be displayed using the spatial light modulator 115. This hologram pattern conversion processing requires a different conversion method for each type of the spatial light modulator 115.

When the spatial light modulator 115 is a phase-only SLM, the complex number field needs to be converted into a phase-only field in order to display the hologram on the spatial light modulator 115. However, the present invention is not limited thereto, and various other encoding methods may be used. For example, a method such as an amplitude discard method, a Gerchberg-Saxton algorithm, or a dual-phase encoding algorithm may be used.

In the present example, as described above, a case where the dual-phase encoding algorithm is used will be exemplified. In this case, the following Formulas (3) to (6) are used as the calculation formula.

$$\begin{matrix}[ Math . 3 ] & \\ U ( x , y ) = A ( x , y ) {e}^{ip ( x , y )} & ( 3 )\end{matrix}$$

$$\begin{matrix}[ Math . 4 ] & \\ a ( x , y ) = \frac{A ( x , y )}{{A}_{max}} & ( 4 )\end{matrix}$$

$$\begin{matrix}[ Math . 5 ] & \\ {p}_{a} = p + {cos}^{- 1} a & ( 5 )\end{matrix}$$

$$\begin{matrix}[ Math . 6 ] & \\ {p}_{b} = p - {cos}^{- 1} a & ( 6 )\end{matrix}$$

Here, U(x, y) is a complex plane. A(x, y) is an amplitude component. p(x, y) is a phase component. a(x, y) is a normalized amplitude. Amax is the maximum value of the amplitude component. Pa and Pb are phase-only signals (phase signals) for displaying the hologram pattern on the spatial light modulator 115.

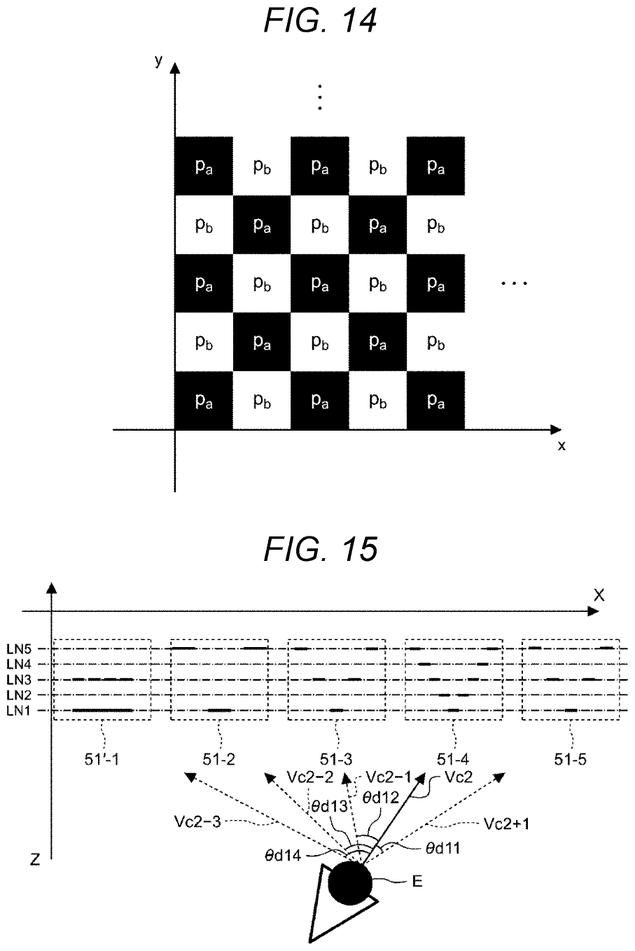

More specifically, as illustrated in FIG. 14, Pa and Pb are alternately changed like a checkerboard pattern in order to form a phase-only signal (phase signal) for displaying the hologram pattern on the spatial light modulator 115. Since the checkerboard pattern is fixed, the encoding processing can be executed so that Pa and Pb in Formulas (3) to (6) are calculated for each pixel of the spatial light modulator 115. Note that, since both Pa and Pb are phase values, even when the values calculated by Formulas (3) to (6) exceed the range supportable by the spatial light modulator 115, they can be dropped into the range of 0 to 2π.

In step S39, the interference fringe conversion unit 134 inputs the phase signal of the generated hologram pattern to the spatial light modulator 115 that modulates the incident light Le. Then, the spatial light modulator 115 modulates the incident light Le on the basis of the input phase signal. In addition, the spatial light modulator 115 displays a hologram image including a hologram pattern as a modulation result by reflecting the hologram image via the beam splitter 114.

In step S40, it is determined whether or not the end of the process has been instructed, and when the end of the process has not been instructed, the process returns to step S31, and the subsequent processes are repeated. Then, when the end of the process is instructed in step S40, the process ends.

Through the above process, the virtual object 11 having a line-of-sight parallax angle closer to the line-of-sight direction has a larger number of layers (number of samplings) in the depth direction, and the interval between the layers is set narrower. Furthermore, the number of layers in the depth direction is reduced and the interval between the layers is set wider for the virtual object 11 having a line-of-sight visual difference farther from the line-of-sight direction. Then, the hologram image generated by setting the number of layers in this manner is displayed.

More specifically, the virtual object 11 having a smaller line-of-sight parallax angle close to the line-of-sight direction and in a range close to the central visual field has a larger number of layers in the depth direction, and the interval between the layers is set to be narrower. As a result, in the range of the central visual field in which the shape and color of the object can be recognized with high sensitivity by the user's eye E, it is possible to display the virtual object in which the depth direction is expressed in detail. On the other hand, the number of layers in the depth direction is reduced and the interval between the layers is set to be wider for the virtual object 11 in the range of the peripheral visual field away from the central visual field having a larger line-of-sight parallax angle away from the line-of-sight direction. As a result, in the range of the peripheral visual field having a large line-of-sight parallax angle, the virtual object is expressed with the expression in the depth direction simplified. However, in the peripheral visual field having a large line-of-sight parallax angle, the user's eye E can only recognize the shape and color of the object vaguely, and thus the influence is small.

To sum up, the number of layers expressing the depth direction is reduced according to the magnitude of the line-of-sight parallax angle. In other words, as the distance from the central visual field increases, the number of layers gradually decreases and the interval between the layers increases. As a result, the number of layers of the virtual object in the hologram image viewed with the user's eye E gradually decreases and naturally changes according to the distance from the central visual field, and the virtual object corresponds to the sensitivity change of the eye E, so that it is possible to realize expression without discomfort at the time of viewing. In addition, the number of layers of all the virtual objects in the peripheral visual field, which is a region wider than the limited central visual field with respect to the region of the entire hologram image, is reduced, and the interval between the layers is widened. As a result, the calculation amount of the entire hologram image can be effectively reduced. As a result, it is possible to display a hologram image with a high stereoscopic effect and no sense of discomfort while reducing the overall calculation amount related to the CGH technology and realizing low latency and power saving.

Note that, in the above description, an example has been described in which the number of layers of the depth value to be the value in the depth direction is reduced as the line-of-sight parallax angle, which is the angle formed by the line-of-sight direction and the virtual object direction, increases, and resampling is performed such that the interval between the layers increases. However, as described above, when the virtual object direction is within the central visual field, the human eye can sufficiently visually recognize the shape and color. Therefore, when the virtual object can be regarded as being within the central visual field on the basis of the line-of-sight parallax angle, resampling may be performed at narrowest intervals between the layers with the maximum number of layers regardless of the magnitude of the line-of-sight parallax angle. On the other hand, when the virtual object can be regarded as being within the peripheral visual field, the number of layers may be reduced as the line-of-sight parallax angle increases, and resampling may be performed such that the interval between the layers becomes wider.

Furthermore, when the virtual object can be regarded as being within the central visual field on the basis of the line-of-sight parallax angle, the depth value may be resampled at a first interval between the layers with the first number of layers being the maximum number regardless of the magnitude of the line-of-sight parallax angle. On the other hand, when it can be regarded that the virtual object exists in the peripheral visual field, the resampling may be performed at a second interval between the layers wider than the first interval between the layers with the second number of layers being smaller than the first number of layers regardless of the magnitude of the line-of-sight parallax angle. In this case, only two types of the number of layers and layer intervals are switched and displayed between the virtual object in the central visual field and the virtual object in the peripheral visual field. Even if the types of switching of the number of layers and the intervals are small as described above, the number of layers in the peripheral visual field is reduced as compared with the number of layers in the central visual field, so that it is possible to appropriately reduce the calculation amount related to the CGH technology in a simple manner.

### 3. First Modification

In the above description, an example of configuring the layer LN3 has been described when the number of layers of the virtual object in the object direction having a large line-of-sight parallax angle is one, for example, as indicated by the depth distribution 51-1 in FIG. 7. However, in the end, all the texture information is propagated to the layer LN1 closest to the eye E by the occlusion processing. Therefore, in the resampling, when the number of layers is one, the layer may be discretized to the layer LN1 closest to the eye E to reduce the number of calculations in the occlusion processing.

For example, as illustrated in FIG. 15, the line-of-sight parallax angle is θd14 (>θd13) for the virtual object 11-1 in which the object direction is the direction Vc2−3 with respect to the line-of-sight direction Vc2. Therefore, the depth distribution 21-1 corresponding to the virtual object 11-1 may be resampled as in the depth distribution 51′-1. The depth distribution 51′-1 is discretized into only one layer LN1 closest to the eye E, which is less than the number of layers set in the virtual object 11-2. With such processing, the processing of propagating the texture information of the layer LN3 to the layer LN1 can be omitted, so that the number of calculations in the occlusion processing can be reduced. Note that, in the depth distribution 51′-1 of FIG. 15, a dotted line portion of the layer LN3 indicates an example of resampling when the layer LN3 is discretized into one layer LN3 in FIG. 7, and a solid line portion indicates an example of resampling when the layer LN3 is discretized into the layer LN1.

### 4. Second Modification

In the above, an example has been described in which the depth direction is resampled according to the line-of-sight parallax angle, which is an angle formed by the line-of-sight direction and the object direction, such that the number of layers decreases as the line-of-sight parallax angle increases. However, the number of layers may be set including the element of the distance from the user's eye E to the virtual object displayed on the display surface (SLM position) of the spatial light modulator 115 in addition to the line-of-sight parallax angle.

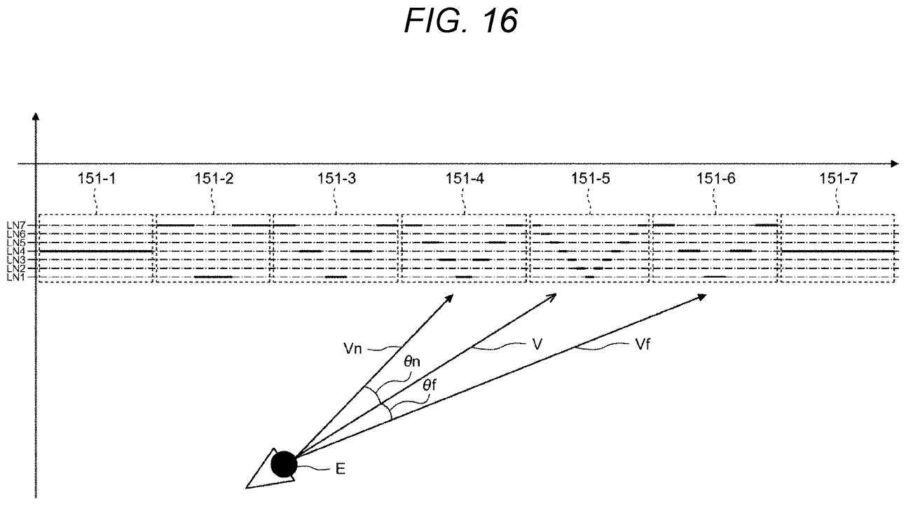

For example, as illustrated in FIG. 16, a case where the depth map is resampled in a range of seven layers as the maximum value with respect to seven virtual objects (not illustrated) having a shape similar to the virtual object 11 in FIG. 1 will be considered. That is, the depth distributions 151-1 to 151-7 in FIG. 16 are resampled in a range of seven layers LN1 to LN7 as the maximum number.

At this time, the depth distributions 151-1 and 151-7 have the number of layers of 1 and are resampled to the layer LN4. Further, the depth distribution 151-2 has the number of layers of 2, and is resampled to two layers LN1 and LN7. Further, the depth distributions 151-3 and 151-6 have the number of layers of 3, and are resampled to three layers LN1, LN4, and LN7. Further, the depth distribution 151-4 has the number of layers of 4, and is resampled to four layers LN1, LN3, LN5, and LN7. Then, in the depth distribution 151-5 in the line-of-sight direction, resampling is performed to seven layers LN1 to LN7 in which the number of layers is the maximum number.

Here, for the depth distributions 151-4 and 151-6, the line-of-sight parallax angles that are the angles formed by the line-of-sight direction V and the virtual object directions Vn and Vf are expressed as θn and θf, respectively. As illustrated in FIG. 16, the line-of-sight parallax angles θn and θf can be considered as approximate values (θn≈θf). Therefore, when the number of layers is set only by the line-of-sight parallax angle, both are set as the same number of layers.

However, the virtual object expressed by the depth distribution 151-6 is farther in distance from the user's eyes E than the virtual object expressed by the depth distribution 151-4. That is, the distances from the eye E of the virtual object expressed by the depth distribution 151-6 and the depth distribution 151-4 are not the same. For this reason, it can be considered that both are not the same in the degree of blurring, that is, the degree of depth blur.

Therefore, in the example of FIG. 16, by setting the number of layers of the depth distribution 151-6 to 3, which is smaller than the number of layers of 4 of the depth distribution 151-4 expressing the virtual object at the position closer to the eye E, the change in the depth blur according to the difference in the distance from the eye E is expressed. That is, in the case of virtual objects having the same line-of-sight parallax angle, the number of layers and the interval thereof are set according to the distance from the eye E.

More specifically, when virtual objects having different distances from the eye E exist at the same line-of-sight parallax angle, the number of layers is reduced as the distance from the eye E to the virtual object increases, and the interval between the layers is set to be wider. As a result, even virtual objects having the same line-of-sight parallax angle can be expressed by adding a depth blur with a suppressed degree to a virtual object in the line-of-sight direction, the virtual object being relatively close in distance from the eye E. On the other hand, even in the case of virtual objects having the same line-of-sight parallax angle, a virtual object relatively far in distance from the eye E can be expressed by adding a strong depth blur to the virtual object in the line-of-sight direction.

As described above, the number of layers may be set by adding the element of the distance from the eye E to the line-of-sight parallax angle for each virtual object, and the number of layers may be reduced and the layer interval may be widened as the line-of-sight parallax angle is larger and the distance from the eye is farther. As a result, the change in depth blur can be gently expressed, and the depth of field can be increased. That is, as the focus position of the eye E is farther, the depth of field based on the focus position of the eye E can be made deeper.

### 5. Example Executed by Software

Meanwhile, the above-described series of processing can be executed by hardware, but can also be executed by software. When the series of processing is executed by software, a program constituting the software is installed from a recording medium to a computer incorporated in dedicated hardware or, for example, a general-purpose computer or the like capable of executing various functions by installing various programs.

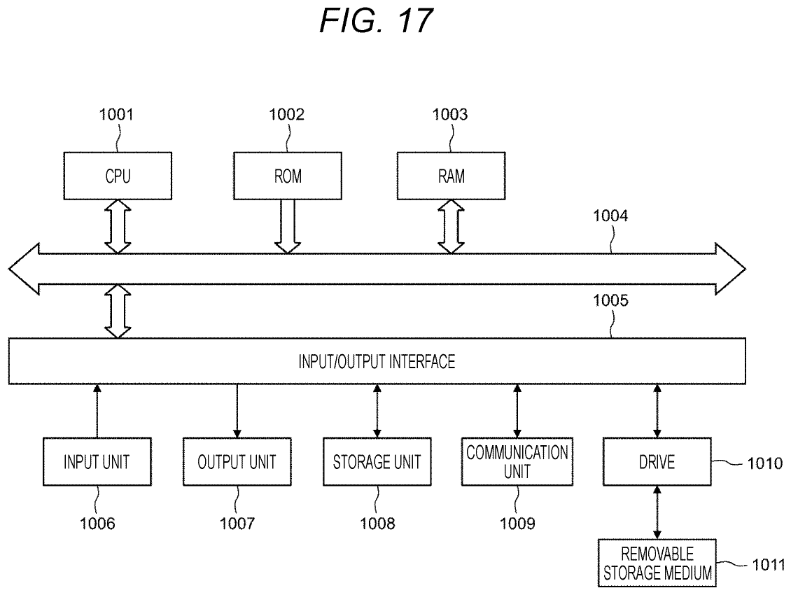

FIG. 17 illustrates a configuration example of a general-purpose computer. This computer incorporates a central processing unit (CPU) 1001. An input/output interface 1005 is connected to the CPU 1001 via a bus 1004. A read only memory (ROM) 1002 and a random access memory (RAN) 1003 are connected to the bus 1004.

The input/output interface 1005 is connected with an input unit 1006 including an input device such as a keyboard or a mouse with which a user inputs an operation command, an output unit 1007 that outputs a processing operation screen or an image of a processing result to a display device, a storage unit 1008 including a hard disk drive or the like that stores a program or various data, and a communication unit 1009 including a local area network (LAN) adapter or the like that executes communication processing via a network represented by the Internet. Furthermore, a drive 1010 that reads and writes data from and to a removable storage medium 1011 such as a magnetic disk (including a flexible disk), an optical disk (including a compact disc-read only memory (CD-ROM) and a digital versatile disc (DVD)), a magneto-optical disk (including a mini disc (MD)), or a semiconductor memory is connected.

The CPU 1001 executes various processes according to a program stored in the ROM 1002 or a program read from a removable storage medium 1011 such as a magnetic disk, an optical disk, a magneto-optical disk, or a semiconductor memory, installed in the storage unit 1008, and loaded from the storage unit 1008 to the RAM 1003. The RAM 1003 also appropriately stores data and the like necessary for the CPU 1001 to execute various processes.

In the computer configured as described above, for example, the CPU 1001 loads a program stored in the storage unit 1008 into the RAM 1003 via the input/output interface 1005 and the bus 1004 and executes the program, whereby the above-described series of processing is performed.

The program executed by the computer (CPU 1001) can be provided by being recorded in the removable storage medium 1011 as a package medium or the like, for example. Furthermore, the program can be provided via a wired or wireless transmission medium such as a local area network, the Internet, or digital satellite broadcasting.

In the computer, the program can be installed in the storage unit 1008 via the input/output interface 1005 by attaching the removable storage medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

Note that the program executed by the computer may be a program in which processing is performed in time series in the order described in the present specification, or may be a program in which processing is performed in parallel or at necessary timing such as when a call is made.

Note that the CPU 1001 in FIG. 17 implements the functions of the modulation control unit 116 in the present specification.

In addition, in the present specification, a system means a set of a plurality of components (apparatuses, modules (parts), or the like), and it does not matter whether or not all the components are in the same housing. Therefore, a plurality of apparatuses housed in separate housings and connected via a network and one apparatus in which a plurality of modules is housed in one housing are both systems.

Note that the embodiments of the present disclosure are not limited to the above-described embodiments, and various modifications can be made without departing from the gist of the present disclosure.

For example, the present disclosure can have a configuration of cloud computing in which one function is shared and processed in cooperation by a plurality of apparatuses via a network.

Furthermore, each step described in the above-described flowchart can be executed by one apparatus or can be shared and executed by a plurality of apparatuses.

Furthermore, when a plurality of processes is included in one step, the plurality of processes included in the one step can be executed by one apparatus or can be shared and executed by a plurality of apparatuses.

Note that the present disclosure can also have the following configurations.

<1> A display processing apparatus including:
a gaze information acquisition unit that acquires gaze information of a user from a sensor;
a resampling processing unit that resamples a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and
a wavefront propagation processing unit that performs wavefront propagation processing of color data of the three-dimensional data on the basis of the depth data resampled by the resampling processing unit and generates a propagation signal representing a hologram.

<2> The display processing apparatus according to <1>, in which
the resampling processing unit resamples the sampling interval of the depth data for each virtual object expressed by the three-dimensional data in the central visual field of the user corresponding to the line-of-sight direction of the user based on the gaze information to be narrower than the sampling interval of the depth data for each virtual object expressed by the three-dimensional data in the peripheral visual field of the user.

<3> The display processing apparatus according to <2>, in which
the resampling processing unit resamples the sampling interval of the depth data for each virtual object expressed by the three-dimensional data in the central visual field of the user to be narrower than the sampling interval of the depth data for each virtual object expressed by the three-dimensional data in the peripheral visual field of the user on the basis of the line-of-sight direction of the user and a virtual object direction that is a direction from the viewpoint of the user to the virtual object.

<4> The display processing apparatus according to <3>, in which
the resampling processing unit resamples the sampling interval of the depth data for each virtual object expressed by the three-dimensional data in the central visual field of the user to be narrower than the sampling interval for each depth data of the virtual object expressed by the three-dimensional data in the peripheral visual field of the user on the basis of a line-of-sight parallax angle which is an angle formed by the line-of-sight direction of the user and the virtual object direction.

<5> The display processing apparatus according to <4>, in which
the resampling processing unit is configured to
   resample the sampling interval of the depth data of the virtual object to be narrower as the line-of-sight parallax angle decreases, and resample the sampling interval of the depth data of the virtual object to be wider as the line-of-sight parallax angle increases for each virtual object,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

<6> The display processing apparatus according to <4>, in which
the resampling processing unit is configured to:
   resample the sampling interval of the depth data at a predetermined narrowest interval when the virtual object can be regarded as being within the central visual field on the basis of the line-of-sight parallax angle for each virtual object; and
   resample the sampling interval of the depth data of the virtual object to be wider as the line-of-sight parallax angle increases when the virtual object can be regarded as being in the peripheral visual field on the basis of the line-of-sight parallax angle for each virtual object,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

<7> The display processing apparatus according to <4>, in which
the resampling processing unit is configured to:
   resample the sampling interval of the depth data at a first interval when the virtual object can be regarded as being within the central visual field on the basis of the line-of-sight parallax angle for each virtual object; and
   resample the sampling interval of the depth data at a second interval wider than the first interval when the virtual object can be regarded as being in the peripheral visual field on the basis of the line-of-sight parallax angle for each virtual object,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

<8> The display processing apparatus according to <3>, in which
the resampling processing unit resamples to a layer closest to the user when there is one layer for resampling the depth data for each virtual object expressed by the three-dimensional data.

<9> The display processing apparatus according to <3>, in which
the resampling processing unit resamples the sampling interval of the depth data for each virtual object expressed by the three-dimensional data in the central visual field of the user to be narrower than the sampling interval for each depth data of the virtual object expressed by the three-dimensional data in the peripheral visual field of the user on the basis of a line-of-sight parallax angle which is an angle formed by the line-of-sight direction of the user and the virtual object direction and a distance to the virtual object.

<10> The display processing apparatus according to <9>, in which
the resampling processing unit is configured to:
   for each virtual object,
      resample the sampling interval of the depth data of the virtual object to be narrower as the line-of-sight parallax angle decreases and as the distance to the virtual object decreases; and
      resample the sampling interval of the depth data of the virtual object to be wider as the line-of-sight parallax angle increases and as the distance to the virtual object increases,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

<11> The display processing apparatus according to any one of <1> to <10>, in which
the depth data and the color data of the three-dimensional data are generated by rendering the three-dimensional data.

<12> The display processing apparatus according to any one of <1> to <11>, further including
a spatial light modulator that generates the hologram by modulating incident light from a light source on the basis of the propagation signal.

<13> The display processing apparatus according to <12>, in which
the spatial light modulator is a phase-only spatial light modulator or an amplitude-only spatial light modulator.

<14> The display processing apparatus according to any one of <1> to <13>, in which
the gaze information acquisition unit includes a sensor that captures an image of an eye or a face of the user, and acquires the image of the eye or the face of the user captured by the sensor as gaze information for specifying the line-of-sight direction of the user.

<15> The display processing apparatus according to any one of <1> to <13>, in which
the gaze information acquisition unit includes an inertial sensor provided in equipment worn on a head of the user, and acquires a signal acquired by the inertial sensor as gaze information for specifying the line-of-sight direction of the user.

<16> The display processing apparatus according to <15>, in which
the equipment worn on the head of the user is an augmented reality head mounted display (ARHMD).

<17> A display processing method including the steps of:
acquiring gaze information of a user from a sensor;
resampling a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and
performing wavefront propagation processing of color data of the three-dimensional data on the basis of the depth data resampled and generating a propagation signal representing a hologram.

<18> A storage medium storing a program for causing a computer to function as:
a gaze information acquisition unit that acquires gaze information of a user from a sensor;
a resampling processing unit that resamples a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and
a wavefront propagation processing unit that performs wavefront propagation processing of color data of the three-dimensional data on the basis of the depth data resampled by the resampling processing unit and generates a propagation signal representing a hologram.

### REFERENCE SIGNS LIST

101 Display system
111 Light source
112, 113 Lens
114 Beam splitter
115 Spatial light modulator
116 Modulation control unit
117 Line-of-sight detection unit
131 Three-dimensional image rendering unit
132 Resampling processing unit
133 Wavefront propagation unit
134 Interference fringe conversion unit

1. A display processing apparatus comprising:
a gaze information acquisition unit that acquires gaze information of a user from a sensor;
a resampling processing unit that resamples a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and
a wavefront propagation processing unit that performs wavefront propagation processing of color data of the three-dimensional data on a basis of the depth data resampled by the resampling processing unit and generates a propagation signal representing a hologram.

2. The display processing apparatus according to claim 1, wherein
the resampling processing unit resamples the sampling interval of the depth data for each virtual object expressed by the three-dimensional data in the central visual field of the user corresponding to the line-of-sight direction of the user based on the gaze information to be narrower than the sampling interval of the depth data for each virtual object expressed by the three-dimensional data in the peripheral visual field of the user.

3. The display processing apparatus according to claim 2, wherein
the resampling processing unit resamples the sampling interval of the depth data for each virtual object expressed by the three-dimensional data in the central visual field of the user to be narrower than the sampling interval of the depth data for each virtual object expressed by the three-dimensional data in the peripheral visual field of the user on a basis of the line-of-sight direction of the user and a virtual object direction that is a direction from the viewpoint of the user to the virtual object.

4. The display processing apparatus according to claim 3, wherein
the resampling processing unit resamples the sampling interval of the depth data for each virtual object expressed by the three-dimensional data in the central visual field of the user to be narrower than the sampling interval for each depth data of the virtual object expressed by the three-dimensional data in the peripheral visual field of the user on a basis of a line-of-sight parallax angle which is an angle formed by the line-of-sight direction of the user and the virtual object direction.

5. The display processing apparatus according to claim 4, wherein
the resampling processing unit is configured to
resample the sampling interval of the depth data of the virtual object to be narrower as the line-of-sight parallax angle decreases, and resample the sampling interval of the depth data of the virtual object to be wider as the line-of-sight parallax angle increases for each virtual object,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

6. The display processing apparatus according to claim 4, wherein
the resampling processing unit is configured to:
resample the sampling interval of the depth data at a predetermined narrowest interval when the virtual object can be regarded as being within the central visual field on a basis of the line-of-sight parallax angle for each virtual object; and
resample the sampling interval of the depth data of the virtual object to be wider as the line-of-sight parallax angle increases when the virtual object can be regarded as being in the peripheral visual field on a basis of the line-of-sight parallax angle for each virtual object,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

7. The display processing apparatus according to claim 4, wherein
the resampling processing unit is configured to:
resample the sampling interval of the depth data at a first interval when the virtual object can be regarded as being within the central visual field on a basis of the line-of-sight parallax angle for each virtual object; and
resample the sampling interval of the depth data at a second interval wider than the first interval when the virtual object can be regarded as being in the peripheral visual field on a basis of the line-of-sight parallax angle for each virtual object,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

8. The display processing apparatus according to claim 3, wherein
the resampling processing unit resamples to a layer closest to the user when there is one layer for resampling the depth data for each virtual object expressed by the three-dimensional data.

9. The display processing apparatus according to claim 3, wherein
the resampling processing unit resamples the sampling interval of the depth data for each virtual object expressed by the three-dimensional data in the central visual field of the user to be narrower than the sampling interval for each depth data of the virtual object expressed by the three-dimensional data in the peripheral visual field of the user on a basis of a line-of-sight parallax angle which is an angle formed by the line-of-sight direction of the user and the virtual object direction and a distance to the virtual object.

10. The display processing apparatus according to claim 9, wherein
the resampling processing unit is configured to:
for each virtual object,
resample the sampling interval of the depth data of the virtual object to be narrower as the line-of-sight parallax angle decreases and as the distance to the virtual object decreases; and
resample the sampling interval of the depth data of the virtual object to be wider as the line-of-sight parallax angle increases and as the distance to the virtual object increases,
to resample the sampling interval of the depth data for each virtual object expressed by the three-dimensional data in the central visual field of the user to be narrower than the sampling interval of the depth data for each virtual object expressed by the three-dimensional data in the peripheral visual field of the user.

11. The display processing apparatus according to claim 1, wherein
the depth data and the color data of the three-dimensional data are generated by rendering the three-dimensional data.

12. The display processing apparatus according to claim 1, further comprising
a spatial light modulator that generates the hologram by modulating incident light from a light source on a basis of the propagation signal.

13. The display processing apparatus according to claim 12, wherein
the spatial light modulator is a phase-only spatial light modulator or an amplitude-only spatial light modulator.

14. The display processing apparatus according to claim 1, wherein
the gaze information acquisition unit includes a sensor that captures an image of an eye or a face of the user, and acquires the image of the eye or the face of the user captured by the sensor as gaze information for specifying the line-of-sight direction of the user.

15. The display processing apparatus according to claim 1, wherein
the gaze information acquisition unit includes an inertial sensor provided in equipment worn on a head of the user, and acquires a signal acquired by the inertial sensor as gaze information for specifying the line-of-sight direction of the user.

16. The display processing apparatus according to claim 15, wherein
the equipment worn on the head of the user is an augmented reality head mounted display (ARHMD).

17. A display processing method comprising the steps of:
acquiring gaze information of a user from a sensor;
resampling a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and
performing wavefront propagation processing of color data of the three-dimensional data on a basis of the depth data resampled and generating a propagation signal representing a hologram.

18. A storage medium storing a program for causing a computer to function as:
a gaze information acquisition unit that acquires gaze information of a user from a sensor;
a resampling processing unit that resamples a sampling interval of depth data of three-dimensional data in a central visual field of the user corresponding to a line-of-sight direction of the user based on the gaze information to be narrower than a sampling interval of the depth data of the three-dimensional data in a peripheral visual field of the user; and
a wavefront propagation processing unit that performs wavefront propagation processing of color data of the three-dimensional data on a basis of the depth data resampled by the resampling processing unit and generates a propagation signal representing a hologram.
